(19) United States
(12) Patent Application Publication
(10) Pub. No.: US 2003/0112719 A1
(43) Pub. Date: Jun. 19, 2003

(54) Optical pickup actuator

(75) Inventors: Sam Nyol Hong, Suwon-si (KR); In Ho Choi, Seongnam-si (KR); Min Suk Suh, Seongnam-si (KR); Kwan Woo Park, Seongnam-si (KR)

Correspondence Address: LEE & HONG, 801 SOUTH FIQUEROA STREET, 14TH FLOOR, LOS ANGELES, CA, 90017, US

(73) Assignee: LG Electronics Inc.

(21) Appl. No.: 10/320,013

(22) Filed: Dec. 16, 2002

(30) Foreign Application Priority Data
Dec. 19, 2001 (KR) 81426/2001

(51) Int. Cl. G11B 7/00

(52) U.S. Cl. 369/44.16

(57) ABSTRACT

An optical pickup actuator is provided to improve a driving property in a radial direction. In accordance with the optical pickup actuator of the present invention, radial coils are wired in predetermined locations of both side parts of a lens holder. In addition, ends of existing fixed members are curved and protruded outside. Magnets for radial coil are attached to the protruded part. Therefore, a mass to be applied to the lens holder is minimized and an excellent driving property is ensured in focusing and tracking directions as well as in a radial direction, thereby simplifying the structure and decreasing the cost.

### BACKGROUND OF THE INVENTION

1. Field of the Invention

The present invention relates to an optical pickup actuator, and more particularly to an optical pickup actuator for enhancing a driving property in a radial direction.

2. Background of the Related Art

Recently, due to rapid development of an optical-related disc media, an optical pickup actuator for reading or writing information stored in a disc has been developed all the various ways.

As such an optical pickup actuator, a two-pivots actuator has developed initially. This two-pivots actuator includes a focusing coil and a tracking coil within a magnetic field of a lens holder on which an object lens is rested and enables the driving of the lens holder in a focusing direction or a tracking direction.

However, as high-capacity and high-density of an optical disc have required more and more, it has raised a need to enhance property of an actuator in order to read or write information stored in the high-capacity and high-density optical disc. Particularly, the denser the optical disc gets, the smaller a tilt margin gets. Such a small tilt margin may give a fatal adverse effect to a control system due to mechanical runout or bending of the disc. Accordingly, to implement a stable servo in a drive for recoding and reproducing a high-density disc, an actuator capable of following tilt components of the disc has required keenly. To meet this request, a three-pivots actuator has been developed. This three-pivots actuator has enabled a tilt driving in a radial direction as well as an existing focusing and tracking driving.

FIG. 1 is a view showing the conventional three-pivots driving optical pickup actuator. As shown in FIG. 1, the conventional three-pivots actuator rests an object lens 111 on the protruded part 112 of a lens holder 112. Yokes 114, 114′ are fixed to a pickup base (not shown) at the predetermined front or back location of a hole 124 formed in the lens holder 112. Magnets 113, 113′ are attached on the backsides of the fixed yokes 114, 114′, respectively. In this situation, the magnets 113, 113′ are opposite to each other.

The focusing coil 116 is wired along the inner side plane of the hole 124 of the lens holder 112, while having the magnet 114′ formed in the backside of the hole 124 of the lens holder 112 therein. The tracking coils 115, 115′ are wired on one side plane of the focusing coil 116, perpendicularly to the focusing coil 116. The tracking coils 115, 115′ are formed in two pairs on the side plane of the focusing coil 116.

On the other hand, radial magnets 119, 119′ are attached on one-side parts of wings 118 extended from the left and right sides of the lens holder 112, respectively. Radial coils 120, 120′ are formed, separated by predetermined spaces from the radial magnets 119, 119′. The radial coils 120, 120′ are wired around yokes 126, 126′ coupled to the pickup base.

Also, wire suspensions 117, 117′ are connected between the wings 118 of the lens holder 112 and a damper holder (not shown) to apply a supply voltage to the respective coils (that is, the tracking coil and the focusing coil) and simultaneously support the lens holder 112. Of course, because the radial coils are wired directly around the yokes 126, 126′ fixed on the pickup base, the radial coils are connected directly to a power source.

By constructing the actuator as described the above, the lens holder can be driven in a focusing direction, a tracking direction or a radial direction as needs. That is, in case that the supply voltage is applied to the focusing coil, the lens holder may be driven in the focusing direction, and on the other hand in case that the supply voltage is applied to the tracking coil, the lens holder may be driven in the tracking direction. Also, in case that the supply voltage is applied to the radial coil through a separate power connecting line, the lens holder may be driven in the radial direction.

However, in the conventional three-pivots driving actuator, the yokes to be wired with the radial coils should be wired on the pickup base independently. Accordingly, the process is complicated, the cost is increased and in some cases it is impossible to construe an actuator due to limitation of a slim type of space.

Additionally, the magnets opposed to the radial coils are attached to both sides of the lens holder. Due to the weight of these magnets, a driving sensitivity is lowered in the focus and track directions and a few kHz or a dozen kHz of higher resonance property are deteriorated. Moreover, in a moving magnet type in which the magnets are attached to the lens holder and then operated, magnetic efficiency is significantly lowered.

### SUMMARY OF THE INVENTION

An object of the invention is to solve at least the above problems and/or disadvantages and to provide at least the advantages described hereinafter.

Accordingly, one object of the present invention is to solve the foregoing problems by providing an optical pickup actuator for attaching radial coils directly to a lens holder in place of magnets for radial coils, thereby improving a driving property of a radial direction without effect of vibration

Another object of the present invention is to provide an optical pickup actuator in which magnets for radial coil are attached on yokes formed on both side parts of the existing damper holder, thereby reducing cost.

To achieve the above and other objects, in accordance with a preferred embodiment of the present invention, the optical pickup actuator includes a radial coil being wired in predetermined locations of both side parts of the lens holder in order to drive the lens holder in a radial direction, and magnets for radial coil opposed with a predetermined space to the radial coil and attached to one-side parts of fixed members.

Preferably, the fixed member is a yoke for radial coil to be integrated with the first and second yokes and be fixed to a pickup base. Also, the fixed member is extended in a length direction, whose end is curved and protruded outside.

The magnet for radial coil is attached to the part where the end of the fixed member is curved and protruded outside.

Quadrangle shape of plates are extended outside and formed on the both side parts of the lens holder in which the radial coil is wired. The radial coil is fixed on the quadrangle shape of plate.

The radial coil is changed toward the side direction of the lens holder to put a center of mass and a driving center of the lens holder on same position.

A power connecting line connected to the radial coil is wired loosely between the back-end part of the lens holder and a PCB of the end of the damper holder.

In accordance with a preferred alternative embodiment of the present invention, an optical pickup actuator comprises an object lens rested on a protruded part of a lens holder; a focusing actuator and a tracking actuator for focusing or tracking driving, placed inside a hole of the lens holder, the actuators including the first and second yokes, the first and second magnets, and a focusing coil and a tracking coil; a damper holder for decreasing vibration of the lens holder, fixed members placed on both side parts of the damper holder respectively, fixed to a pickup base and extended in a length direction, whose ends are curved and protruded outside; wire suspensions connected between the both side parts of the lens holder and the damper holder to apply a supply voltage for focusing or tracking driving and simultaneously support the lens holder; radial coils wired in quadrangle shape of plates formed to be extended outside from predetermined locations of the both side parts of the lens holder; magnets for radial coil opposed with a predetermined space to the radial coils and attached to the parts where the ends of the fixed members are curved and protruded; and a power connecting line for radial coil connected to the radial coils via a hole of the lens holder inside the damper holder to apply a supply voltage to the radial coils.

The quadrangle shape of plates are integrated with the lens holder.

In accordance with a preferred another embodiment of the invention, the center of mass and the driving center of the lens holder are put on same position by the use of the radial coils wired in the both side parts of the lens holder in place of a mass balance formed on the back-end part thereof.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 shows a conventional three-axis driving optical pickup actuator;

FIG. 2 shows a three-axis driving actuator in accordance with a preferred embodiment of the present invention;

FIG. 3 is a side view of the three-axis driving actuator of FIG. 2; and

FIG. 4 shows a lens holder for adjusting a center of mass by the use of radial coils shown in FIG. 2.

### DETAILED DESCRIPTION OF PREFERRED EMBODIMENTS

Now, a preferred embodiment of the invention will be described in reference to the accompanying drawings.

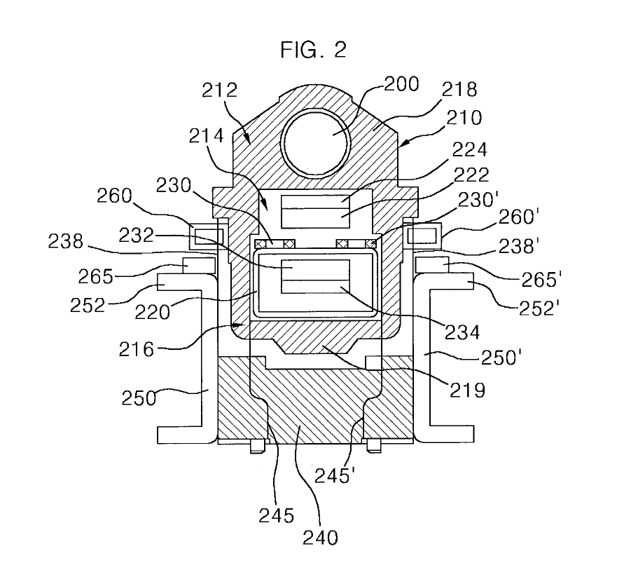

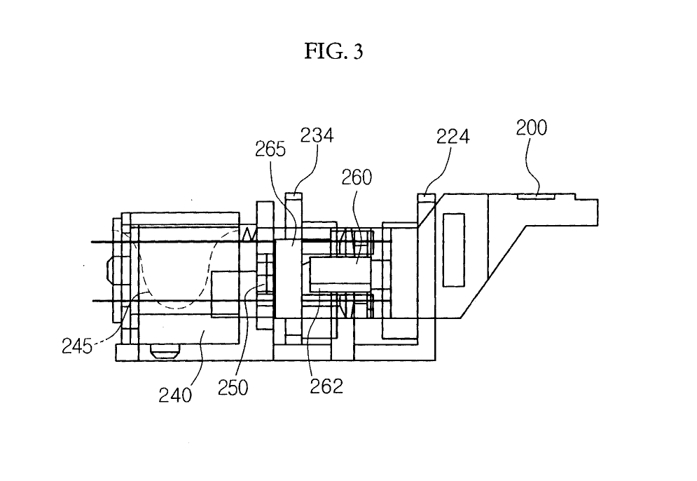

FIG. 2 is a plane view showing a three-axis driving actuator in accordance with a preferred embodiment of the present invention. FIG. 3 is a side view of the three-axis driving actuator of FIG. 2.

Referring to FIG. 2 and 3, the three-axis driving actuator includes an object lens 200 rested on a protruded part 218 of the lens holder 210. The object lens 200 condenses a light beam outputted from a laser diode on an information recording surface of an optical disc.

The lens holder 210 consists of the protruded part 218 formed in the front-end part 212 and a quadrangle hole 214 formed in the center part of the lens holder 210. As described the above, the object lens 200 is placed to condense the light beam on a predetermined location of the protruded part 218. Inside the quadrangle hole 214, the first and second yokes 224, 234 are fixed to a pickup base (not shown) in the predetermined front and back locations respectively. The first and second magnets 222, 232, which are opposed to each other, are attached to the backsides of the first and second yokes 224, 234. Because the first and second magnets 222, 232 are permanent magnets, a magnetic field is always formed. In this situation, because the first and second yokes 224, 234 exist on the backsides of the first and second magnets 222, 232, the magnetic field is mainly formed in the space between the first and second magnets 222, 232.

A focusing coil 220, which has the second yoke 234 and the second magnet 232 therein, is wired around the inner side plane of the hole 214 of the lens holder 210.

In addition, on one side plane of the focusing coil 220, tracking coils 230, 230′ are wired to be perpendicular to the focusing coil 220. The tracking coils 230, 230′ are formed in a pair on one side plane of the focusing coil 220.

On the both side parts of the lens holder 210, the respective fixed wire suspensions 238, 238′ are extended and fixed to a PCB (not shown) of the end of the damper holder 240. The wire suspensions 238, 238′ act to support the lens holder, while applying a supply voltage to the focusing coil 220 and the tracking coils 230, 230′. The wire suspensions 238, 238′ are power connecting lines for applying a supply voltage to the focusing coil 220 and the tracking coils 230, 230′. Two pieces of wire suspensions are fixed to each side part of the lens holder, so that total four suspensions are fixed to the both side parts of the lens holder.

The inner parts of the damper holder 240 are filled with damper to reduce vibration generated from the lens holder 210.

To fix and support the damper holder 250, fixed members 250, 250′ are placed on the both side parts of the damper holder and fixed to the pickup base.

Preferably, the fixed members 250, 250′ are yokes for radial coil, which are integrated with the first and second yokes 224, 234.

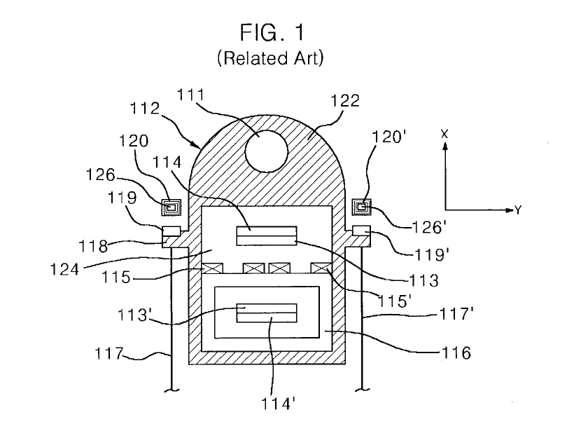

Of course, fixed members for fixing and supporting the damper holder have existed previously. However, the fixed members 250, 250′ of the present invention are different from the previous fixed members in that the shapes thereof are changed in order to attach magnets 265, 265′ for radial coil. That is, the fixed members 250, 250′ of the present invention are extended in a length direction, whose ends are curved to protrude outside. The magnets 265, 265′ for radial coil are attached to the curved and protruded parts 252, 252′. As a result, in accordance with the present invention, such a separate yoke for wiring the radial coils as the conventional art of FIG. 1 is not required by changing the shape of the previous fixed member and attaching the magnets 265, 265′ for radial coil to the both one-side parts of the fixed members. Therefore, the rigidity of the yokes is ensured and accordingly a vibration property is improved, as well as the process is simplified and the cost is reduced.

The radial coils 260, 260′, which are opposed to each other, are wired in the predetermined locations of the both side parts of the lens holder 210, at the locations separated by predetermined spaces from the magnets 265, 265′ for radial coil attached to the both one-side parts of the fixed members 250, 250′. In this situation, a quadrangle shape of plate 262 is formed in the predetermined locations of the both side parts of the lens holder 210 and is protruded outside. It is desirable this quadrangle shape of plate 262 to be integrated with the lens holder 210. Also, it is desirable the both one-side parts of the radial coils 260, 260′ to be placed collinear with the tracking coils 230, 230′. Of course, in this situation, it makes it possible under an assumption that the center of mass and the driving center of the lens holder 210 are putted on same position.

In the other hand, because the radial coils 260, 260′ are wired in the side parts of the lens holder 210, power connecting lines 245, 245′ for applying a supply voltage to the radial coils are required.

The power connecting lines 245, 245′ are connected to the radial coils 260, 260′ via the lens holder 210 inside the damper holder 240.

It is desirable to have the wiring of the power connecting lines 245, 245′ got loose between the back-end part of the lens holder 210 and the PCB (not shown) of the end of the damper holder 240. In case that the power connecting lines 245, 245′ are wired as described the above, when the lens holder 210 is driven in the focusing or tracking direction, the frequency property of an optical pickup actuator is not changed without the effect of a spring constant k

In order to have the wiring of the power connecting lines 245, 245′ got loose, the diameter thereof must be small as possible. Also, it is desirable that a flexible single wire coil or twisted pair wire coil is used as the power connecting lines 245, 245′. In this situation, the twisted pair wire coil means the coil being twisted to one another by several single wire coils.

As apparent from the above description, the driving property is improved, the structure of the actuator is simplified and the cost is reduced, upon driving in a radial direction, by wiring the radial coils having the smaller mass in the predetermined locations of the both side parts of the lens holder, and attaching the magnet for radial coil to the curved and protruded part into which the shape of the existing fixed member is changed.

In the other hand, to put the center of mass and the driving center of the lens holder on same position, a mass balance is formed on the back-end part of the lens holder as shown in FIG. 3. That is, because the object lens is rested on the protruded part of the front-end part of the lens holder, the center of mass is put in the front-end part.

In order to put the center of mass and the driving center of the lens holder on same position, the mass balance having small mass is formed at the back-end part of the lens holder.

The present invention can use the radial coils wired in the both side parts of the lens holder in place of using the mass balance to put the center of mass and the driving center on same position.

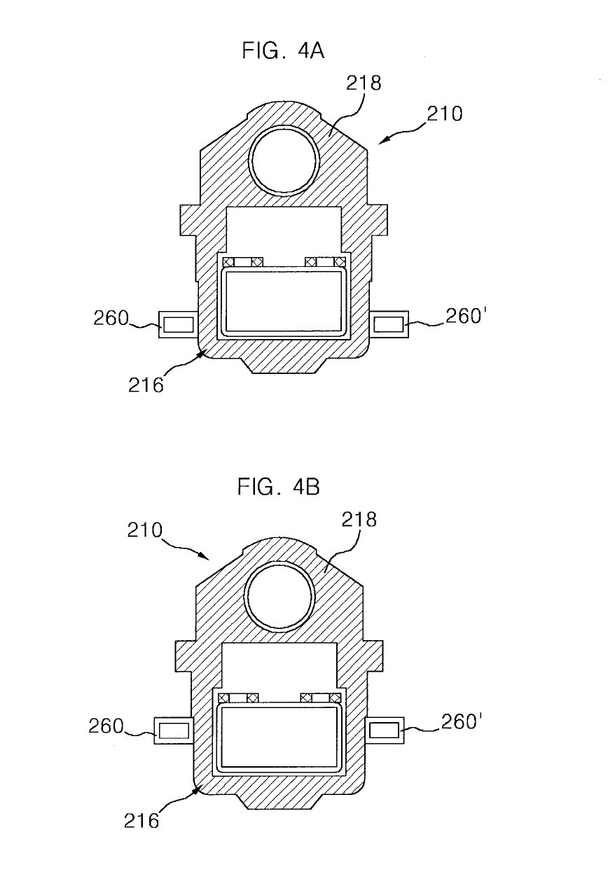

As shown in FIG. 4a, in case that the center of mass is leaned quite toward the front-end part 212, the radial coils 260, 260′ are wired in the both side parts of the back-end part 216 respectively.

Adversely, as shown in FIG. 4b, in case that the center of mass is leaned a little toward the front-end part 212, the radial coils 260, 260′ are moved a little toward the front-end part 212 and are wired respectively.

At this case, the quadrangle shape of plate 262 for fixing the radial coils 260, 260′ to the lens holder 210 can be formed with the lens holder in consideration of the location situation of the center of mass.

As apparent from the above description, in accordance with the optical pickup actuator of the present invention, the driving property is improved significantly in the focusing and tracking directions as well as in the radial direction, by wiring the radial coils to the both side parts of the lens holder and attaching the magnets for radial coil to the curved and protruded parts of the fixed members.

In addition, a separate yoke for radial coil is not required, if compared with the conventional art, thereby reducing the cost and accordingly simplifying the process.

In accordance with the lens holder of the present invention, it enables the radial coils to change in the side direction of the lens holder, based on the location of the center of mass. Therefore, it is not a need of the mass balance to adjust the center of mass and thereby it is possible to decrease the cost and be light-weight.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An optical pickup actuator, comprising:
a lens holder having an object lens rested on the protruded part of the lens holder and a quadrangle hole for forming a predetermined space below the protruded part;
a driving means including, first and second yokes fixed to a pickup base at predetermined front and back locations inside the quadrangle hole of the lens holder, first and second magnets attached to be opposed to each other on the backsides of the first and second yokes, a focusing coil having the second yoke and the second magnet attached to the second yoke therein, the focusing coil wired around the inner side plane of the quadrangle hole of the lens holder, and a tracking coil wired to be perpendicular to the focusing coil on the one-side plane of the focusing coil;
a damper holder for decreasing vibration of the lens holder;
fixed members placed on both side parts of the damper holder respectively and fixed to a pickup base; and
a supporting means for supporting the lens holder and simultaneously applying a supply voltage to the focusing coil and the tracking coil, the supporting means connected between the both side parts of the lens holder and the fixed members,
wherein the optical pickup actuator comprises radial coils wired in predetermined locations of the both side parts of the lens holder to drive the lens holder in a radial direction, and magnets for radial coil opposed with a predetermined space to the radial coils and attached to one-side parts of the fixed members.

2. The optical pickup actuator according to claim 1, wherein the fixed member is a yoke for radial coil.

3. The optical pickup actuator according to claim 1, wherein the fixed member is integrated with the first and second yokes and fixed to the pickup base.

4. The optical pickup actuator according to claim 1, wherein the fixed member is extended in a length direction and the ends of the fixed member are curved and protruded outside.

5. The optical pickup actuator according to claim 1, wherein the magnets for radial coil are attached to the parts where the ends of the fixed member are curved and protruded outside.

6. The optical pickup actuator according to claim 1, wherein a quadrangle shape of plate is extended outside and is formed on both side parts of the lens holder where the radial coil is wired.

7. The optical pickup actuator according to claim 1, wherein the radial coil is fixed to the quadrangle shape of plate.

8. The optical pickup actuator according to claim 1, wherein one side of the radial coil is collinear with the tracking coil.

9. The optical pickup actuator according to claim 1, wherein the radial coil is changed in the side direction of the lens holder to put a center of mass and the driving center of the lens holder on same position.

10. The optical pickup actuator according to claim 1, wherein a power connecting line connected to the radial coil is wired loosely between the back-end part of the lens holder and a PCB of the end of the damper holder.

11. The optical pickup actuator according to claim 10, wherein the power connecting line is a flexible single wire coil.

12. The optical pickup actuator according to claim 10, wherein the power connecting line is a flexible twisted pair wire coil.

13. An optical pickup actuator, comprising:
(a) an object lens rested on the protruded part of a lens holder;
(b) a focusing actuator and a tracking actuator for focusing or tracking driving inside a hole of the lens holder, the actuators including first and second yokes, first and second magnets, a focusing coil and a tracking coil;
(c) a damper holder for decreasing vibration of the lens holder;
(d) fixed members placed on both side parts of the damper holder respectively and fixed to a pickup base, the fixed member extended in a length direction, whose ends are curved and protruded outside;
(e) wire suspensions connected between the both side parts of the lens holder and the damper holder, to apply a supply voltage for focusing or tracking driving and simultaneously support the lens holder;
(f) radial coils wired in a quadrangle shape of plate formed to extend outside from predetermined locations of the both side parts of the lens holder;
(g) magnets for radial coil opposed with a predetermined space to the radial coils and attached to the parts where the ends of the fixed member are curved and protruded outside; and
(h) a power connecting line for radial coil connected to the radial coils to supply a supply voltage to the radial coils.

14. The optical pickup actuator according to claim 13, wherein the quadrangle shape of plate is integrated with the lens holder.

15. The optical pickup actuator according to claim 13, wherein the fixed member is a yoke for radial coil.

16. The optical pickup actuator according to claim 13, wherein the fixed member is integrated with the first and second yokes.

17. The optical pickup actuator according to claim 13, wherein the power connecting line for radial coil is wired loosely between the back-end part of the lens holder and the damper holder.

18. A lens holder including a protruded part formed in the front-end part of the lens holder, a hole formed in the center part of the lens holder, and a mass balance formed in the back-end part of the lens holder,
wherein a center of mass and a driving center of the lens holder are put on same position, by using radial coils wired in both side parts of the lens holder in place of the mass balance formed in the back-end part of the lens holder.
